(19) United States
(12) Patent Application Publication
(10) Pub. No.: US 2024/0097378 A1
(43) Pub. Date: Mar. 21, 2024

(54) ELECTRICAL PLUG CORD SUPPORT DEVICE

(71) Applicant: Tyler Munro, Diamond Bar, CA (US)

(72) Inventor: Tyler Munro, Diamond Bar, CA (US)

(21) Appl. No.: 17/947,900

(22) Filed: Sep. 19, 2022

(51) Int. Cl. H01R 13/58; H01R 13/639

(52) U.S. Cl. CPC H01R 13/5804; H01R 13/6395

(57) ABSTRACT

The electrical plug cord support device disclosed herein may comprise a main body and a plurality of cord support arms that may prevent the undesired disconnection of an electrical plug and also allow for the easy management of excess cord length. The electrical plug cord support device may be installed between an electrical outlet box and a cover plate, and may provide a permanent solution for cleanly and easily preventing unwanted plug disconnection and for storing excess electrical cable length.

### TECHNICAL FIELD OF THE INVENTION

The present invention relates in general to electrical outlets, and, more specifically, to an electrical plug cord support device.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Electrical products, whether fixed or mobile, invariably require a source of power so that they can either be charged or operated. Mobile devices such as vacuums, electric yard trimmers, or electric power tools require power to run their motors before they can be used freely. Fixed devices such as televisions, computers, or refrigerators also require a constant source of power when in use. Such power is generally provided by standardized electrical outlets that are connected to some power source, and into which an electrical plug and cord may be inserted. The shape of such outlets may vary from one country to another, though are generally standardized within a country.

Mobile devices such as vacuums and yard trimmers are usually plugged-in and then operated at some distance away from the power source. As such, they tend to have longer electrical cords than other devices, but their radius of use is limited to this length of the electrical cord. Often when a user is using such a device at the limits of their reach the electrical plug will be pulled out of the power outlet and the device will cease functioning. A user may then add an extension cord to the system to lengthen the radius in which they may use the device, but will run into the same problem again when operating at this new distance limit.

A number of solutions exist in the art for preventing the unwanted disconnecting of outlet plugs, though most of these are permanent solutions. By way of example a device exists that acts as a retainer clip that may be attached to an outlet plug and then screwed into a receiver on the outlet itself. While effective, this solution requires the plug to be permanently installed into the outlet, or is at least inconvenient to use with a mobile device. Another type of solution involves using c-lips or retainers into which the electrical cord itself may be placed as a type of tension absorber. These solutions are less effective because the electrical cord can still be pulled out of the retainer with sufficient tension, and also because they require a separate device to be installed adjacent to the electrical outlet.

Fixed devices such as televisions and refrigerators are usually placed permanently on a surface or within a cabinet. The distance from the power-consuming device to the power outlet is traversed by the electrical cord, which may vary in length depending on manufacturer specifications, user selections, and certain design considerations. The length of this electrical cord, though, is never exactly as desired, and may be either too long or too short for a specific application. Where the electrical cord is too short a user may add in an extension cord to ensure that the overall length of the combined cords is sufficient. When the electrical cord is too long, though, the user is left with determining how to deal with the excess length.

A number of solutions exist in the art for dealing with excess cord length, though most of these solutions are improvised. By way of example a user may roll up the excess length of cord and then ziptie the rolled section so that it remains bound. There are a number of more formal bindings available on the market that also achieve the same function and purpose. Another solution for excess cord length is the use of a reel around which the excess cord length may be wound. The advantage of using is a reel is that the excess cord length may be easily utilized when needed, though this advantage has no use in the case of fixed devices. A third solution known in the art is the use of a block around which the excess length of cord may be wound, though such blocks do not have a dedicated location of their own, and their bulk must be placed and hidden by the user. No solution exists to allow an excess length of cord to be cleanly and simply wound and stored.

Thus, there is a need in the art for an electrical plug cord support device that may comprise a main body and a plurality of cord support arms that may prevent the undesired disconnection of an electrical plug and also allow for the easy management of excess cord length. The electrical plug cord support device may be installed between an electrical outlet box and a cover plate, and may provide a permanent solution for cleanly and easily preventing unwanted plug disconnection and for storing excess electrical cable length. It is to these ends that the present invention has been developed.

### BRIEF SUMMARY OF THE INVENTION

To minimize the limitations in the prior art, and to minimize other limitations that will be apparent upon reading and understanding the present specification, the present invention describes an electrical plug cord support device.

It is an objective of the present invention to provide an electrical plug cord support device that may comprise a main body.

It is another objective of the present invention to provide an electrical plug cord support device that may comprise a mounting plate.

It is another objective of the present invention to provide an electrical plug cord support device that may comprise an outlet opening.

It is another objective of the present invention to provide an electrical plug cord support device that may comprise a plurality of outlet box mounting holes.

It is another objective of the present invention to provide an electrical plug cord support device that may comprise a plurality of cover plate mounting holes.

It is another objective of the present invention to provide an electrical plug cord support device that may comprise an upper cord support.

It is another objective of the present invention to provide an electrical plug cord support device that may comprise a lower cord support.

It is another objective of the present invention to provide an electrical plug cord support device that may comprise a plurality of cord notches.

It is another objective of the present invention to provide an electrical plug cord support device that may comprise a resilient material of construction.

It is another objective of the present invention to provide an electrical plug cord support device that may comprise a water-proof material of construction.

It is another objective of the present invention to provide an electrical plug cord support device that may comprise a reusable material of construction.

It is another objective of the present invention to provide an electrical plug cord support device that may comprise an antioxidizing layer.

It is another objective of the present invention to provide an electrical plug cord support device that may comprise an antioxidizing material of construction.

It is another objective of the present invention to provide an electrical plug cord support device that may comprise an antimicrobial layer.

It is another objective of the present invention to provide a pivoting and extending interchangeable hand tool device that may comprise an antimicrobial material of construction.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

The preferred embodiments and examples of the claimed subject matter will hereinafter be described in conjunction with the appended drawings provided to illustrate and not to limit the scope of the claimed subject matter, where like designations denote like elements, and in which:

FIG. 1 illustrates a front plan view of an electrical plug cord support device, as contemplated by the present disclosure;

FIG. 2 illustrates a rear plan view of an electrical plug cord support device, as contemplated by the present disclosure;

FIG. 3 illustrates a right side elevation view of an electrical plug cord support device, as contemplated by the present disclosure;

FIG. 4 illustrates a left side elevation view of an electrical plug cord support device, as contemplated by the present disclosure;

FIG. 5 illustrates a top plan view of an electrical plug cord support device, as contemplated by the present disclosure;

FIG. 6 illustrates a bottom plan view of an electrical plug cord support device, as contemplated by the present disclosure;

FIG. 7 illustrates an isometric perspective view of an electrical plug cord support device, as contemplated by the present disclosure;

FIG. 8 illustrates an isometric perspective view of an electrical plug cord support device as it would be installed between an electrical outlet box and electrical outlet cover, as contemplated by the present disclosure;

FIG. 9 illustrates an isometric perspective view of an electrical plug cord support device as it would be installed between an electrical outlet box and electrical outlet cover; and

FIG. 10 illustrates an isometric perspective view of an electrical plug cord support device as it would support an electrical plug cord, as contemplated by the present disclosure.

### DETAILED DESCRIPTION OF THE INVENTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary, or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The present invention relates in general to electrical outlets, and, more specifically, to an electrical plug cord support device. As contemplated by the present disclosure, the electrical plug cord support device may comprise a main body and a plurality of cord support arms that may prevent the undesired disconnection of an electrical plug and also allow for the easy management of excess cord length. The electrical plug cord support device may be installed between an electrical outlet box and a cover plate, and may provide a permanent solution for cleanly and easily preventing unwanted plug disconnection and for storing excess electrical cable length.

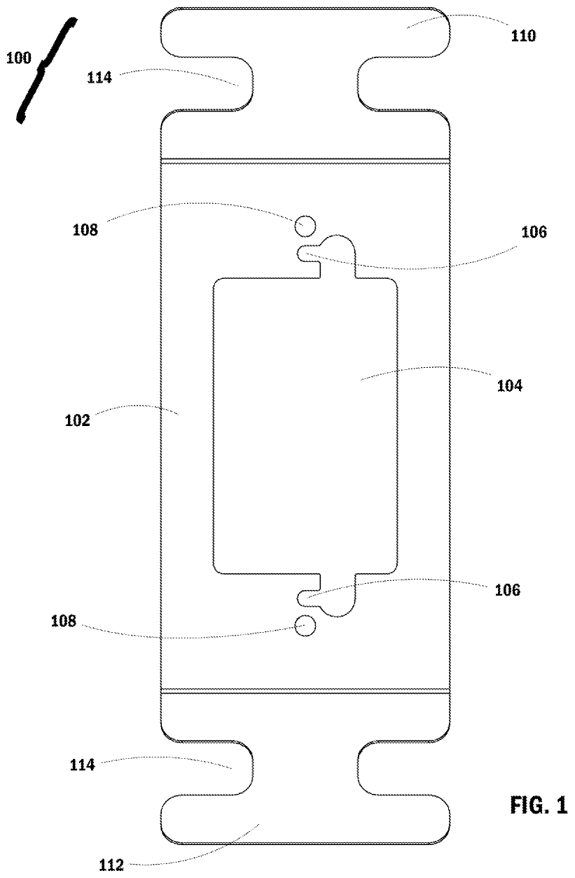

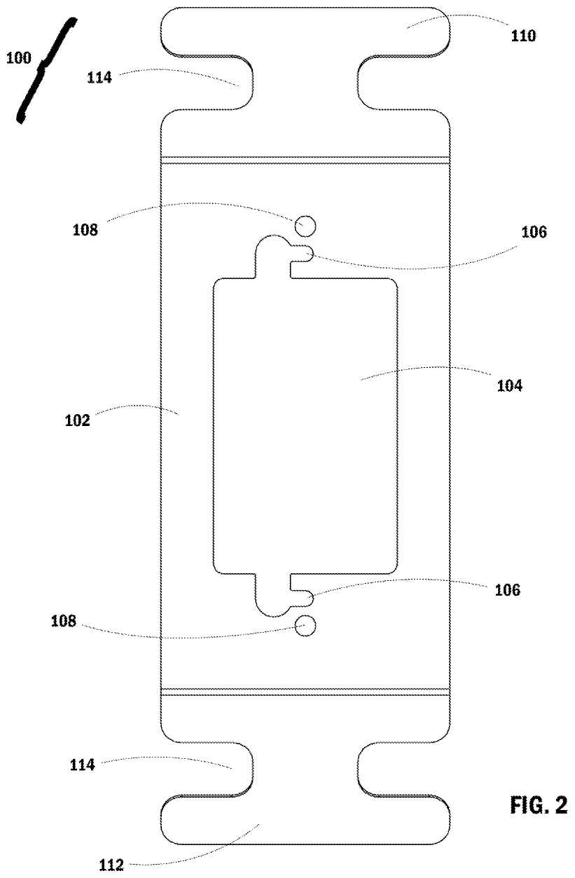

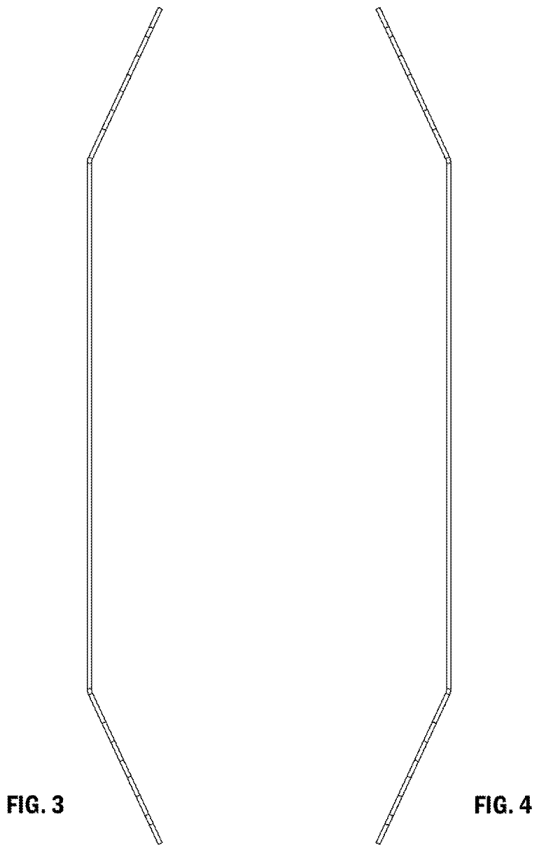

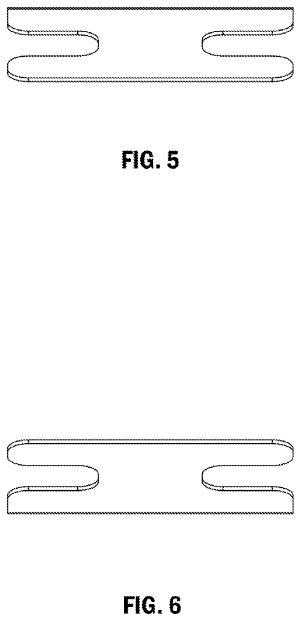

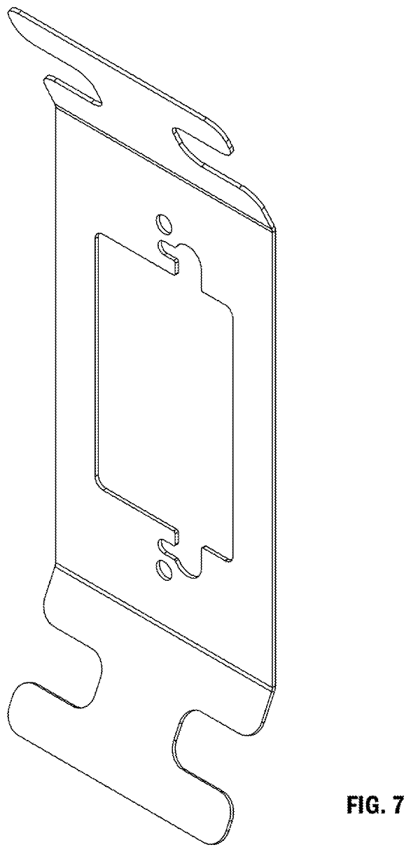

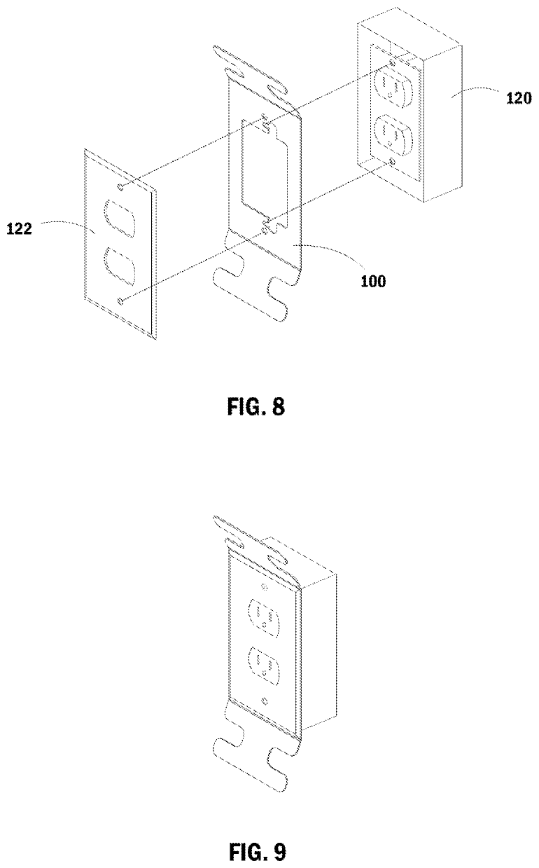

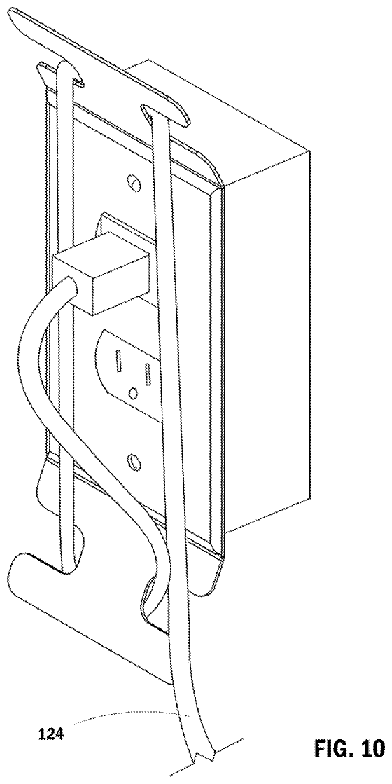

The illustrations of FIGS. 1 through 10 illustrate an electrical plug cord support device, as contemplated by the present disclosure. The device may comprise, generally, a main body 100 that may be permanently installed on a standard electrical outlet assembly. The main body 100 may comprise a mounting plate 102, which may be a plate designed to be installed onto a standard electrical outlet box 120. The mounting plate 102 may comprise an outlet opening 104, which may comprise an opening in the center of the mounting plate 102 sufficient to allow for standard electrical outlets to pass through the mounting plate 102.

The mounting plate 102 may further comprise a plurality of outlet box mounting holes 106, which may comprise a plurality of holes that allow the mounting plate 102 to be attached to a standard electrical outlet box 120. The attachment of the mounting plate 102 to a standard electrical outlet box 120 may be by any appropriate means but is most commonly by screwing. The mounting plate 102 may further comprise a plurality of cover plate mounting holes 108, which may comprise a plurality of holes that allow a standard cover plate 122 to be attached to the mounting plate 102. The attachment of the cover plate 122 to the mounting plate 102 may be by any appropriate means but is most commonly by screwing.

The main body 100 may further comprise an upper cord support 110, which may be a notched plate attached to an upper edge of the mounting plate 102. The upper cord support 110 may be attached to the mounting plate 102 at an angle such that the two components are not in the same plane but are offset at some acute angle. The upper cord support 110 may further comprise a plurality of cord notches 114, which may comprise a pair of notches that allow an electrical cord to be wrapped around the upper cord support 110 and held in place by the shape of the design. The attachment of the upper cord support 110 to the mounting plate 102 may be by any appropriate means such as, for example, welding, bolting, adhering, or riveting. In one embodiment the upper cord support 110 and the mounting plate 102 may be made from one continuous sheet of material.

The main body 100 may further comprise a lower cord support 112, which may be a notched plate attached to a lower edge of the mounting plate 102. The lower cord support 112 may be attached to the mounting plate 102 at an angle such that the two components are not in the same plane but are offset at some acute angle. The lower cord support 112 may further comprise a plurality of cord notches 114, which may comprise a pair of notches that allow an electrical cord to be wrapped around the lower cord support 112 and held in place by the shape of the design. The attachment of the lower cord support 112 to the mounting plate 102 may be by any appropriate means such as, for example, welding, bolting, adhering, or riveting. In one embodiment the lower cord support 112 and the mounting plate 102 may be made from one continuous sheet of material.

To begin using the device a user may first remove a standard outlet cover plate 122 from a standard electrical outlet box 120. The user may then attach the main body 100 to the standard electrical outlet box 120 by screwing the mounting plate 102 to the standard electrical outlet box 120 via the plurality of outlet box mounting holes 106. The user may then attach the cover plate 122 to the mounting plate 102 via the plurality of cover plate mounting holes 108.

After the electrical plug cord support device has been installed the user may insert a standard electrical plug into one of the standard electrical plug outlets and then wrap the electrical cord 124 around the upper cord support 110 and lower cord support 112 by inserting the electrical cord 124 into the various cord notches 114 of the device. The user may wrap the electrical cord 124 as many times as desired before continuing to the power-consuming device. By this function any tension placed on the electrical cord is canceled by the upper cord support 110 and lower cord support 112, and thus, the electrical plug will remain plugged into the electrical outlet.

The electrical plug cord support device may be substantially constructed of any suitable material or combination of materials, but typically is constructed of a resilient material or combination of materials such that the device is easily manufactured, resistant to damage, and reusable. As an example, and without limiting the scope of the present invention, various exemplary embodiments of the pivoting and extending interchangeable hand tool device may be substantially constructed of one or more materials of steel, stainless steel, iron, aluminum, brass, fiberglass, carbon fiber, plastic, acrylic, polycarbonate, or combinations thereof. In some embodiments the various components of the device may be coated, lined, or otherwise insulated to prevent contamination of the device.

In one embodiment the electrical plug cord support device may comprise a resilient material of construction that either comprises a material having antioxidizing properties or comprises a layering of antioxidizing material or coating to prevent oxidation damage to the device and its components. In one embodiment the electrical plug cord support device may comprise a resilient material of construction that either comprises a material having antimicrobial properties or comprises a layering of antimicrobial material or coating to prevent contamination of the device and its components. Copper and its alloys, in particular, have exceptional desirable effects. Silver also has these effects, and is less toxic to users than copper.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims.

I claim:

1. An electrical plug cord support device, comprising:
a mounting plate;
an upper cord support; and
a lower cord support;
wherein said mounting plate further comprises an outlet opening, a plurality of outlet box mounting holes, and a plurality of cover plate mounting holes;
wherein said outlet opening comprises an opening within said mounting plate sufficient to allow a plurality of standard power outlets to pass through;
wherein said plurality of outlet box mounting holes comprise a pair of holes through said mounting plate;
wherein said plurality of cover plate mounting holes comprise a pair of holes through said mounting plate;
wherein said mounting plate further comprises an upper edge and a lower edge;
wherein said upper cord support further comprises a plurality of cord notches and a lower edge;
wherein said lower edge of said upper cord support is attached to said upper edge of said mounting plate at an acute angle;
wherein said plurality of cord notches comprise a pair of notches within both a first side and a second side of said upper cord support;
wherein said lower cord support further comprises a plurality of cord notches and an upper edge;
wherein said upper edge of said lower cord support is attached to said lower edge of said mounting plate at an acute angle; and
wherein said plurality of cord notches comprise a pair of notches within both a first side and a second side of said lower cord support;
